(19) United States
(12) Patent Application Publication
(10) Pub. No.: US 2014/0176277 A1
(43) Pub. Date: Jun. 26, 2014

(54) COMMON MODE FILTER HAVING SIGNAL COMPENSATION FUNCTION

(71) Applicant: Samsung Electro-Mechanics Co., Ltd., Suwon-si (KR)

(72) Inventors: Geon Se CHANG, Suwon-si (KR); Sung Kwon Wi, Suwon-si (KR)

(73) Assignee: Samsung Electro-Mechanics Co., Ltd., Suwon-si (KR)

(21) Appl. No.: 14/137,694

(22) Filed: Dec. 20, 2013

(30) Foreign Application Priority Data
Dec. 21, 2012 (KR) 10-2012-0150767

(51) Int. Cl. H01F 27/30; H01F 27/28

(52) U.S. Cl. CPC H01F 27/30; H01F 27/2804
USPC 336/185

(57) ABSTRACT

Disclosed herein is a common mode filter having a signal compensating function, including: a magnetic substance substrate included as a base of the common mode filter; a first conductor coil portion that is formed on a surface of the magnetic substance substrate and is included to remove common mode noise generated in a circuit; and a second conductor coil portion that is electrically connected to the first conductor coil portion to be formed on an upper portion of the first conductor coil portion, and is included to compensate for a signal reduction portion of the circuit due to removal of noise by using the first conductor coil portion.

### CROSS REFERENCE(S) TO RELATED APPLICATIONS

This application claims the benefit under 35 U.S.C. Section 119 of Korean Patent Application Serial No. 10-2012-0150767, entitled “Common Mode Filter Having Signal Compensating Function” filed on Dec. 21, 2012, which is hereby incorporated by reference in its entirety into this application.

### BACKGROUND OF THE INVENTION

1. Technical Field

The present invention relates to a common mode filter, and more particularly, to a common mode filter having a signal compensating function, which enables signal transmission without loss by compensating for a signal reduction of a noise-filtered signal.

2. Description of the Related Art

As electronic devices increasingly have multiple functions and are reduced in size, common mode noise inevitably occurs in circuits such as high speed interfaces (Universal Serial Bus (USB) 2.0, USB 3.0, High-Definition Multimedia Interface (HDMI), etc.) which use a differential transmission mode.

Currently, a common mode filter uses the principle of generating impedance in conductor coils surrounding a magnetic substance in the same direction so as to remove the common mode noise.

Here, a common phenomenon seen in most noise filters including filters in regard to common mode noise is that when noise mixed in a signal is removed by a filtering function, magnitude of the signal is reduced together. In addition, the signal, which is reduced in magnitude by the noise filter, is further repeatedly reduced in magnitude after passing through other devices. This consequently causes malfunction of a device, and such phenomenon is generated more particularly when using signals of a high frequency region.

Meanwhile, a common mode filter that has an additional configuration for compensation of signals which are reduced in magnitude after filtering the common mode noise has not been presently available. Common mode filters provided up to the present have a multi-layer thin film structure with a plurality of conductor coil portions for removing common mode noise. The conductor coil portions comprise a plurality of conductor coil portions that are designed such that electrical signals flow in the same direction.

A signal current is in a differential mode in which two strands of conductive lines are used as an outward path and a return path, and thus, magnetic fluxes generated in respective coil centers of the outward path and the return path are in reverse directions so as to be offset by each other and the signal current flows (through the conductive lines?). Also, common mode noise currents flow in the same direction, and thus a magnetic flux generated in a core is synthesized to be stronger. As a result, a noise reduction function is intensified, thereby removing the common mode noise currents.

As described above, when removing noise as above, the absolute magnitude of a signal basically simultaneously decreases.

### SUMMARY OF THE INVENTION

An object of the present invention is to provide a common mode filter having a signal compensating function, which additionally includes a unit for compensating for a signal reduction of a noise-filtered signal to thereby compensate for signal reduction and transmit a signal without loss.

According to an exemplary embodiment of the present invention, there is provided a common mode filter having a signal compensating function, including: a magnetic substance substrate included as a base of the common mode filter; a first conductor coil portion that is formed on a surface of the magnetic substance substrate and is included to remove common mode noise generated in a circuit; and a second conductor coil portion that is electrically connected to the first conductor coil portion to be formed on an upper portion of the first conductor coil portion, and is included to compensate for a signal reduction portion of the circuit due to removal of noise by using the first conductor coil portion.

The second conductor coil portion may be formed of a primary coil and a secondary coil, wherein the number n2 of windings in the secondary coil is greater than the number n1 of windings in the primary coil.

The primary coil and the secondary coil may be wound around the same magnetic substance core.

### BRIEF DESCRIPTION OF THE DRAWINGS

FIG. 1 illustrates a structure of a common mode filter having a signal compensating function according to an embodiment of the present invention;

FIG. 2 is a schematic view for explaining a detailed function of a common mode filter having a signal compensating function according to an embodiment of the present invention; and

FIG. 3 is a schematic view for explaining a relationship between numbers of windings in a primary coil and a secondary coil of a second conductor coil portion for signal compensation in a common mode filter having a signal compensating function according to an embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Throughout the specification, it will also be understood that when a component “includes” an element, unless there is another opposite description thereto, it should be understood that the component does not exclude another element but may further include another element. In addition, terms such as “. . . unit”, “device,” “. . . module”, “apparatus” or the like refer to units that perform at least one function or operation, and the units may be implemented as hardware or software or as a combination of hardware and software.

Hereinafter, exemplary embodiments of the present invention will be described in detail with reference to the accompanying drawings.

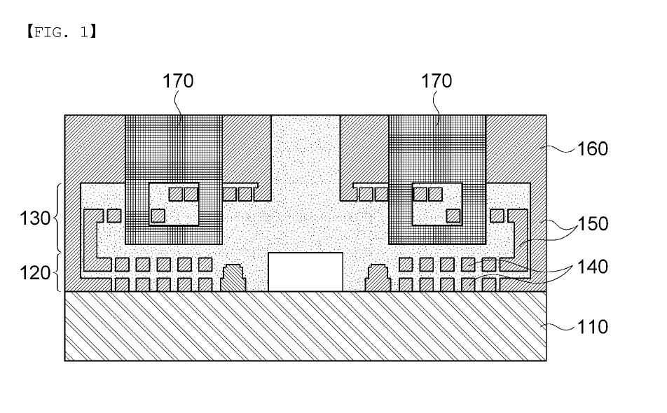

FIG. 1 illustrates a structure of a common mode filter 100 having a signal compensating function according to an embodiment of the present invention.

Referring to FIG. 1, the common mode filter having a signal compensating function according to the exemplary embodiment of the present invention includes a magnetic substance substrate 110, a first conductor coil portion 120, and a second conductor coil portion 130.

The magnetic substance substrate 110 is included as a base of the common mode filter. The magnetic substance substrate 110 may be formed of any material having a good permeability. For example, the magnetic substance substrate 110 may be formed of iron, silicon steel, permalloy, manganese, zinc, ferrite, or the like. In other words, the magnetic substance substrate 110 may be formed of one of iron, silicon steel, permalloy, manganese, zinc, and ferrite or a composite including at least two of these.

The first conductor coil portion 120 is formed on a surface of the magnetic substance substrate 110 to remove common mode noise generated in a circuit. Here, the first conductor coil portion 120 may have a single layer structure but may preferably have a multi-layer structure. When the first conductor coil portion 120 is formed of a multi-layer structure, the number of windings (coiling number) in conductor coils increases, and a magnetic flux generated when a current flows through the coils increases accordingly, and thus, noise may be sufficiently removed.

The second conductor coil portion 130 is electrically connected to the first conductor coil portion 120 to be formed on an upper portion of the first conductor coil portion 120, and performs the function of compensating for a signal reduction portion of a circuit due to removal of noise by using the first conductor coil portion 120. In FIG. 1, a reference numeral 140 denotes a conductor coil, a reference numeral 150 denotes a lead line connecting the conductor coil 140 and an external electrode, reference numeral 160 denotes the external electrode, and reference numeral 170 denotes a core formed of a magnetic composite.

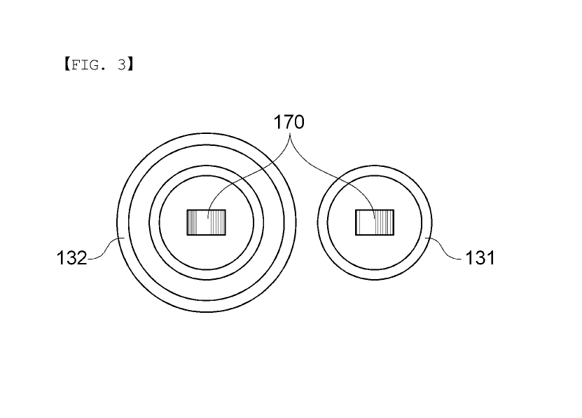

Here, the second conductor coil portion 130 is formed of a primary coil 131 and a secondary coil 132 as illustrated in FIG. 3, and preferably, the second conductor coil portion 130 is formed such that the number n2 of windings in the secondary coil 132 is greater than the number n1 of windings in the primary coil 131.

In addition, the primary coil 131 and the secondary coil 132 are wound round the same magnetic substance core 170 (magnetic composite).

The common mode filter 100 according to the exemplary embodiment of the present invention having the above-described structure includes a conductor coil layer (the second conductor coil portion 130) that performs the function of compensating for a signal reduction portion of a noise-filtered signal, in addition to a conductor coil layer (the first conductor coil portion 120) of a conventional common mode filter. The main principle is the use of two conductor coil structures that are wound around the same magnetic substance having a closed circuit structure.

Here, the two conductor coils are to have different numbers of windings. When the numbers of windings of the two conductor coils are different, electromagnetic induction occurs between the two conductor coils. In other words, a following relationship is established when a signal supplied to a coil at an end (input unit) is input to a coil at the other end.

That is, while assuming coil numbers of the two, the primary coil 131 and the secondary coil 132 of the second conductor coil portion 130 that performs signal compensation as n1 (primary coil) and n2 (secondary coil), respectively, when a current signal is input to the primary coil 131, a magnetic flux is generated in the magnetic substance core 170 at the primary coil 131 by a current flowing through the primary coil 131, and the magnetic flux crosses (interlinks) the secondary coil 132 via the magnetic substance core 170. Here, a magnetic flux is generated in the magnetic substance core 170 in the secondary coil 132 in a direction so as to disturb a change in the magnetic flux, and an electromotive force is generated by the magnetic flux to thereby allow a current to flow. Here, a signal of the secondary coil 132 with respect to a signal input to the primary coil 131 may be expressed by the following equations.

$$\frac{{V}_{1}}{{V}_{2}} = \frac{{n}_{1}}{{n}_{2}} , {V}_{2} = {V}_{1} \cdot \frac{{n}_{2}}{{n}_{1}}$$

Here, V₁ denotes magnitude of a signal whose magnitude is reduced after common mode noise is removed, that is, magnitude of a signal (voltage) input to the primary coil 131, and V₂ denotes magnitude of the signal (voltage) output from the secondary coil 132.

As shown in the above equations, if the coil numbers of the primary and secondary coils 131 and 132 wound around the same magnetic substance core 170 are different, magnitude of the signal (voltage) of the two, primary and secondary coils 131 and 132, varies according to electromagnetic induction.

In other words, when the coil number n2 of the secondary coil 132 is greater than the coil number n1 of the primary coil 131, an input signal is amplified by a relative ratio of n₂/n₁ to be output.

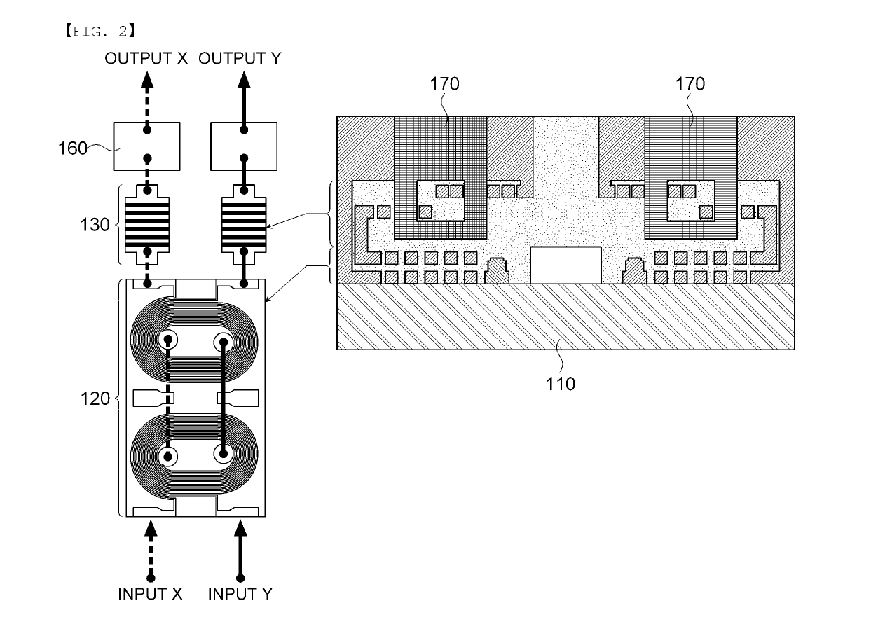

FIG. 2 is a schematic view for explaining a detailed function of the common mode filter 100 having a signal compensating function according to an embodiment of the present invention.

Referring to FIG. 2, as magnitude of generated common mode noise varies according to types and locations of an electronic device to which a filter is applied, the coil numbers n1 and n2 of the secondary coil portion 130 for signal compensation vary accordingly. A signal of a 180-degree phase input in a differential transmission circuit is input to each of an input terminal X and an input terminal Y, and as the signal passes through the first conductor coil portion 120 for removing noise, noise is removed, and then, the signal is input to the second conductor coil portion 130 again for signal compensation.

In the second conductor coil portion 130, the signal is amplified by a degree corresponding to a signal reduction portion reduced by the electromagnetic induction and is transferred to a circuit in the device through the external electrode 160. Thus, the common mode filter 100 having a signal compensation function according to the exemplary embodiment of the present invention may be manufactured based on the above-described principle.

As described above, according to the common mode filter having a signal compensating function of the embodiments of the present invention, as a conductor coil portion for compensating for a signal reduction portion is further included in addition to a conductor coil portion for removing common mode noise, a reduction portion of a differential transmission signal may be compensated after noise filtering with respect to the signal.

In addition, as the magnitude of a signal with respect to noise is amplified, not only performance of a device may be improved but a signal (circuit) may also be protected against unexpected noise which may occur depending on a status of an external device connected to the device.

According to the embodiments of the present invention, as a conductor coil portion for compensating for a signal reduction portion is further included in addition to a conductor coil portion for removing common mode noise, a reduction portion of a differential transmission signal that is reduced after noise filtering of the signal may be compensated, and as an magnitude of a signal compared to noise is amplified, performance of a device may be improved. In addition, a signal may be protected against noise which may occur unexpectedly depending on a condition of an external device connected to the device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions, and substitutions should also be understood to fall within the scope of the present invention.

What is claimed is:

1. A common mode filter having a signal compensating function, comprising:
a magnetic substance substrate included as a base of the common mode filter;
a first conductor coil portion that is formed on a surface of the magnetic substance substrate and is included to remove common mode noise generated in a circuit; and
a second conductor coil portion that is electrically connected to the first conductor coil portion to be formed on an upper portion of the first conductor coil portion, and is included to compensate for a signal reduction portion of the circuit due to removal of noise by using the first conductor coil portion.

2. The common mode filter according to claim 1, wherein the second conductor coil portion is formed of a primary coil and a secondary coil,
wherein the number n2 of windings in the secondary coil is greater than the number n1 of windings in the primary coil.

3. The common mode filter according to claim 2, wherein the primary coil and the secondary coil are wound around the same magnetic substance core.

4. The common mode filter according to claim 1, wherein the magnetic substance substrate is formed of any one of iron, silicon steel, permalloy, manganese, zinc, and ferrite, or a composite including at least two thereof.

5. The common mode filter according to claim 1, wherein the first conductor coil portion has a multi-layer structure.
